(19) United States
(12) Patent Application Publication
(10) Pub. No.: US 2011/0171452 A1
(43) Pub. Date: Jul. 14, 2011

(54) PROCEDURE FOR MAKING PRE-IMPREGNATED REINFORCED COMPOSITE, AS WELL AS FIBER REINFORCED COMPOSITE, AND THEIR APPLICATION

(76) Inventors: Oswin Öttinger, Metingen (DE); Florian Gojny, Kelkheim (DE); Tobias Kuster, Augsburg (DE)

(21) Appl. No.: 13/012,372

(22) Filed: Jan. 24, 2011

Related U.S. Application Data
(63) Continuation of application No. PCT/EP2009/059445, filed on Jul. 22, 2009.

(30) Foreign Application Priority Data
Jul. 23, 2008 (EP) EP 08104849.8

(51) Int. Cl. B32B 5/16; B29C 70/22; B32B 7/08

(52) U.S. Cl. 428/221; 156/92; 156/93

(57) ABSTRACT

The present invention relates to a method for producing a fiber-clutch reinforced composite material comprising: preparing a fiber clutch, comprising preparing an arrangement of two or more layers of fiber that are partially or completely disposed one on top of the other, wherein one or more fiber layers comprise at least 50 wt.-% of the fibers selected from the group consisting of carbon fibers, precursor fibers of carbon fibers, ceramic fibers and mixtures thereof, affixing at least one fiber layer onto one or more other fiber layers using an affixing binder thread, wherein the affixing binder thread comprises one or more fibers selected from the group consisting of carbon fibers, precursor fibers of carbon fibers, ceramic fibers and mixtures thereof; high temperature treating the fiber clutch at a temperature of at least 400° C. under an inert atmosphere for a high temperature treatment period, impregnating the fiber clutch with at least one binder; curing the impregnated fiber clutch and optionally pressing at least one surface section of at least one surface of the impregnated fiber clutch before beginning and/or at least during a portion of the curing period, wherein a fiber clutch reinforced composite material is formed. The present invention also relates to the use of high temperature treated fiber clutch and to fiber clutch reinforced composite materials.

### CROSS REFERENCE TO RELATED APPLICATIONS

This is a continuation of PCT application No. PCT/EP2009/059445, entitled “METHOD FOR PRODUCING A FIBER-CLUTCH REINFORCED COMPOSITE MATERIAL AND FIBER CLUTCH REINFORCED COMPOSITE MATERIAL, AND USE THEREOF”, filed Jul. 22, 2009, which is incorporated herein by reference.

### BACKGROUND OF THE INVENTION

1. Field of the Invention

The present invention concerns the procedure for making pre-impregnated reinforced composite, as well as fiber reinforced composite, and their application.

2. Description of the Related Art

To make composite materials, fibers are used as either woven or non-woven textile structures, as well as in the form of single loose fibers. One of the advantages of the fibers is that they can be introduced in large quantities and with a comparably even dispersion throughout the composite. Another advantage is that the fibers are embedded in the fabric and usually don't need any additional adhering to each other. The downside is that the making of a fabric involves high costs, especially when it comes to delicate or difficult to weave fibers.

Fiber fabrics, in comparison to tissues, show the advantage that they cost far less to make. But at the same time, fiber fabrics also exhibit a very poor adhesion, which makes their production more difficult, especially from the technical point of view. In order to improve adhesion of fibers, plies can be bonded, linked using the hot melting binding threads or they can be bonded by needling. The procedure for making a composite material based on a fiber structure through the use of chemical binders is described in the patent specification FR 1 394 271.

A compound of plies produced by needling results only in comparatively limited resilient fiber fabrics, while a compound that is bonded or linked using the hot melting binding threads carries the risk of insufficient strength at higher temperatures, because the glue or hot melting binding thread either melt or decompose. When glue or hot melting binding threads melt down or decompose, they can leave residues on the fiber fabric. This is a huge disadvantage particularly in a production of the composite material, because such residues can considerably disrupt the interconnection between the reinforcing fiber fabric and composite material matrix and significantly reduce the load-bearing capacity and lifetime of the composite material.

Therefore there is a need in this field of technology for the development of additional procedures for making the production of fiber reinforced composites easier, and to match the individual raw material components of the composite material, that is—fiber components, the matrix material component and the mounting medium components.

### SUMMARY OF THE INVENTION

The task of the present invention is, therefore, to provide a procedure for the production of fiber reinforced composite material, in which the raw material components are matched, as well as sufficient and reliable integrity of a fiber is maintained during and after production steps, at very high temperatures, in the range of 400° C. to 2700° C. and beyond. Moreover, such procedure should allow for a cheap production of fiber fabric and through that cheap fiber reinforced composite material. The steps of such procedure, in particular the making of fiber fabric, should also be achievable at comparably high speed, to be suitable for a production of fiber reinforced composite materials on an industrial scale. Also, the involved materials should be matched according to the invention procedure in such a way that no distortion or disruption appears in the fiber fabric and/or fiber reinforced composite material after a heating and cooling down.

The invention in one form is directed to a method for producing a fiber-clutch reinforced composite material, comprising:
a) preparing a fiber clutch, comprising,
   preparing an arrangement of two or more layers of fiber that are partially or completely disposed one on top of the other, wherein one or more fiber layers comprise at least 50 wt.-% of fibers selected from the group consisting of carbon fibers, precursor fibers of carbon fibers, ceramic fibers and mixtures thereof;
   affixing at least one fiber layer onto one or more other fiber layers using an affixing binder thread,
   wherein the affixing involves passing the affixing binder thread through at least one fiber layer and through at least one of any of the other fiber layers;
   wherein the affixing binder thread comprises one or more fibers selected from the group consisting of carbon fibers, carbon fiber precursor fibers, ceramic fibers and mixtures thereof;
b) high temperature treatment of the fiber clutch at a temperature of at least 400° C. under an inert atmosphere for a high temperature treatment period;
c) impregnating the fiber clutch treated with high temperature with at least one binder;
d) curing the impregnated fiber clutch during a curing period at a curing temperature of at least 40° C., and optionally pressing at least one surface section of at least one surface of the impregnated fiber clutch before beginning and/or at least during a portion of the curing period, wherein a fiber clutch reinforced composite material is formed; and
e) optionally obtaining a fiber clutch reinforced composite material or composite material product after the curing and optional pressing steps.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a fiber fabric (+/−45° fabric) with a line of carbon fiber precursor fiber yarn;

FIG. 2 shows a fiber fabric (+/−45° fabric) with a line of carbon fiber precursor fiber yarn after treatment at 2000° C.;

FIG. 3 shows a fiber fabric (+/−45° fabric) with a line of carbon fiber yarn after carbonizing at 2000° C.; and

FIG. 4 shows a sheet of carbon fiber reinforced carbon ceramic made from the product shown in FIG. 3.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

The aforedescribed figures show, in an explanatory and not a limiting way, fiber reinforced composite material according to the present invention, and multiple fiber fabric byproducts made during the invention procedure.

The present invention relates to a method for producing a fiber-clutch reinforced composite material, which includes the following steps:
a) this arrangement comprises preparing a fiber clutch of two or more fiber layers that are partially or completely disposed on top of the other, wherein one or more fiber layers comprise at least 50% by wt. fibers selected from the group consists of carbon fibers, precursor fibers of carbon fibers, ceramic fibers and their mixtures, affixing at least one fiber layer onto one or more other layers using an affixing binder thread. b) The fiber clutch is treated at high temperature of at least 400° C. under an inert atmosphere during; c) high temperature impregnation treatment of fiber clutch with at least one binder; d) hardening of the impregnated fiber clutch during a curing period at a curing temperature of at least 40° C. and optionally pressing at least one surface section of the impregnated fiber clutch before beginning and/or at least during a portion of the curing period, wherein a fiber clutch reinforced composite material is formed; e) The present invention also relates to use of the high-temperature treated fiber clutch and to fiber clutch reinforced composite materials.

Furthermore, in the current invention, a fiber layer is prepared according to the following:

A fiber clutch is obtained according to a method, comprising:
a) preparing a fiber clutch, comprising,
   preparing an arrangement of two or more layers of fiber that are partially or completely disposed one on top of the other, wherein one or more fiber layers corresponding to the total weight of the particular fiber layer comprise at least 50 wt.-% of the fibers selected from the group consisting of carbon fibers, precursor fibers of carbon fibers, ceramic fibers and mixtures thereof,
   affixing at least one fiber layer onto one or more other fiber layers using an affixing binder thread,
   wherein the affixing involves the passing of the affixing binder thread through at least one fiber layer and through at least one of the one or more other fiber layers, wherein the affixing binder thread comprises one or more fibers selected from the group consisting of carbon fibers, precursor fibers of carbon fibers, ceramic fibers and mixtures thereof,
b) high temperature treatment of the fiber clutch at a temperature of at least 400° C. under an inert atmosphere for a high temperature treatment period.

In addition, the current invention teaches the use of composite materials, composite products and bonded structured in accordance with the following: Use of a composite material or composite material product for manufacturing furnaces, especially for manufacturing lining for the heating areas of furnaces, heating elements, chemical reaction devices or elements thereof, and hot press molds, the composite material or composite material product including:

A fiber clutch reinforced composite material product or fiber clutch reinforced composite material, obtained according to a method for producing a fiber-clutch reinforced composite material, comprising:
a) preparing a fiber clutch, comprising,
   preparing an arrangement of two or more layers of fiber that are partially or completely disposed one on top of the other, wherein one or more fiber layers comprise at least 50 wt.-% of fibers selected from the group consisting of carbon fibers, precursor fibers of carbon fibers, ceramic fibers and mixtures thereof; affixing at least one fiber layer onto one or more other fiber layers using an affixing binder thread,
   wherein the affixing involves passing the affixing binder thread through at least one fiber layer and through at least one of any of the other fiber layers;
   wherein the affixing binder thread comprises one or more fibers selected from the group consisting of carbon fibers, carbon fiber precursor fibers, ceramic fibers and mixtures thereof;
b) high temperature treatment of the fiber clutch at a temperature of at least 400° C. under an inert atmosphere for a high temperature treatment period;
c) impregnating the fiber clutch treated with high temperature with at least one binder;
d) curing the impregnated fiber clutch during a curing period at a curing temperature of at least 40° C., and optionally pressing at least one surface section of at least one surface of the impregnated fiber clutch before beginning and/or at least during a portion of the curing period, wherein a fiber clutch reinforced composite material is formed; and
e) optionally obtaining a fiber clutch reinforced composite material or composite material product after the curing and optional pressing steps.

In addition, the current invention teaches the use of composite materials, composite products and bonded structured in accordance with the following: Use of a fiber clutch for manufacturing furnaces, especially for manufacturing lining for the heating areas of furnaces, heating elements, chemical reaction devices or elements thereof, and hot press molds, the fiber clutch being obtained according to a method, comprising:
a) Preparing a fiber clutch, comprising,
   preparing an arrangement of two or more layers of fiber that are partially or completely disposed one on top of the other, wherein one or more fiber layers corresponding to the total weight of the particular fiber layer comprise at least 50 wt.-% of the fibers selected from the group consisting of carbon fibers, precursor fibers of carbon fibers, ceramic fibers and mixtures thereof,
   affixing at least one fiber layer onto one or more other fiber layers using an affixing binder thread,
   wherein the affixing involves the passing of the affixing binder thread through at least one fiber layer and through at least one of the one or more other fiber layers, wherein the affixing binder thread comprises one or more fibers selected from the group consisting of carbon fibers, precursor fibers of carbon fibers, ceramic fibers and mixtures thereof,
b) high temperature treatment of the fiber clutch at a temperature of at least 400° C. under an inert atmosphere for a high temperature treatment period.

During the numerous experiments that led to the current invention, it was found that an inventive method provides the manufacture of a fiber clutch-reinforced composite material that is used in coordination with materials that enable manufacture of a high quality composite material. In particular the current invention was surprisingly the production of a composite material based on a fiber clutch that can be heated to temperature of at least 400° C. during the inventive production process under an inert atmosphere and yet it provides a reliable strength and also can be made at a suitable rate in an industrial manufacturing process. The invention also offers an important advantage that can be used to manufacture fiber clutch, which are relatively inexpensive cables with a high number of filaments.

The first of inventive method includes providing a fiber clutch, for example which can provide a reliable strength even after treating at temperature 400° C. under an inert atmosphere and in which the materials are so well adapted with one another that the fiber layer has neither curled nor deformed.

To supply the fiber clutch in first step, an arrangement is provided by two or more fiber layers which may be stacked partially or completely over each other to form one or more fiber layers of at least 50% by weight of fibers selected from the group consisting of carbon (based on the total weight of the respective fiber layer) and thus enable the production of high-quality and durable composite material.

The production of carbon fibers and their precursor fibers, as well as ceramic fibers is known to the experts and as described below.

The term “fiber layer,” as used in the present application includes any layer of fiber from any material or material mixtures. In one fiber clutch it can act particularly in a one-way layer or step-up layer, i.e. a fiber layer for example has a plurality of filaments or yarns, which run generally parallel or substantially parallel in one direction. This can be accomplished by spreading a rope or any parallel arrangement of filaments or yarns. In addition, the term fiber layer is of any order or pattern of filaments or fiber segments of shorter length, for example a non-woven layer. Specially, the fiber layers also have different lengths and/or width measurements or a different shape.

In this particular product, the fiber layer used is with one or more fiber layers and it contains at least 50% wt. including the selected fibers from the group consisting of carbon fiber, precursor fibers of carbon fibers, ceramic fibers and their mixtures in any desired position. This fiber clutch and mixture or both can, for example, be the lowest and the top fiber layer and/or between other layers of fibers, fiber layers which are arranged in a certain manner, and they can be differentiate too.

In addition to carbon fibers, the precursor fibers like ceramic fibers can be included in the fiber layers that an expert can select on the basis of his general knowledge and the teaching of the present invention.

Fiber layer for producing composite materials with excellent properties can be obtained, when at least two, preferably 50% of the total number of fiber layers, preferably all fiber layers of the fiber clutch comprises of selected fibers from a group consisting of carbon fiber, precursor carbon fiber, ceramic fibers and their mixtures. In addition, one or more layers of fibers of composite materials with very good properties for more than 70% by wt., preferably more than 85% by wt., preferably to be more than 92% by wt., especially more than 98% by wt. of fiber includes those selected from the group consisting of carbon fibers precursor carbon fibers, ceramic fibers and their mixtures or consists entirely of these.

Composites can be obtained of very good mechanical strength, when at least one fiber clutch comprises of one ceramic fiber, preferably all fiber layers consists of ceramic fibers, such as a range from 0.5 to 100% by wt., or from 2 to 99% by wt., based on the total weight of fibers in each layer.

In a further step of the method for providing an attachment to fiber clutch, at least one fiber layer is made to mount on one or more fibers layers by binding thread. In particular the process of attaching may include the attachment of the connective thread through at least one fiber layer and one or more additional layers of fibers passed.

The term “attachment” also includes many other particles. They are initially arranged over one another and attached together to process only part of the fiber layers and then more layers of fibers is attached in one or more fiber layers. The first layers of the first manufactured fiber clutch create thus. Moreover, the term “attachment” that two, three or more fiber layers are arranged with more than one fiber layer above each other and secured together.

An additional advantage to this inventive method is that the fiber layer in one or more sections has different numbers of fiber layers. The stretching (or thickness) and resilience of the manufactured product are specifically altered and customized, especially to produce a composite material.

An affixing binder thread may include one or more fibers that are selected from the group consisting of carbon fiber, carbon fiber precursor fibers, ceramic fibers and their mixtures. It should also be noted that there was a drawback in the technique so far, the binding yarns on the basis of materials with high brittleness and/or breaking vulnerability, such that carbon fibers and their precursor fibers and ceramic fibers are not suitable for operations as compared to a thread which on several occasions is bent by a small bending radius, especially when such production takes place at an industrial scale and at a high production speed, thus it was assumed the thread would break completely.

Especially, one or more carbon fiber-precursor fiber of the mounting thread will be selected from the group consisting of pre-oxidized viscose fibers, pre-oxidized polyacrylonitrile fibers, pre-oxidized textile fiber, phenolic resin fibers, pitch based precursor fibers and their mixtures. In addition, one or more carbon fiber-precursor fiber of a fiber layer, are selected from the group consisting of pre-oxidized viscose fibers, pre-oxidized polyacrylonitrile fibers, pre-oxidized textile fiber, phenolic resin fibers, pitch-based precursor fibers and their mixtures. The terms pre-oxidized polyacrylonitrile fiber (commonly referred to often as PAN-Ox-fiber), phenolic resin fiber, pitch-based precursor fiber is well known and are described below in detail. The term “textile fiber” includes any known to the expert in textile fiber, especially textile fibers that contain or consist of carbon compounds.

One or more ceramic fibers of the mounting thread and/or one or more ceramic fibers of a fiber layer can be selected from the group consisting of basalt fibers, based on Si, C, B, N, Al or their combinations, glass fibers, fibers based on aluminum oxide, fibers based on zirconium oxide, fibers based on TiC, fibers based on WC and their mixtures. Preferably, one or more ceramic fibers are selected from the group consisting of basalt fibers, and fibers comprising or consisting of, SiNC, SiBNC, SiC, B4C, BN, Si3N4, aluminum oxide, zirconium oxide, TiC, WC and their mixtures and mixtures from these. The term “fibers on basis of a material” as used in the context of the present invention describes that the fibers can consist of a specific material or include this. The above mentioned ceramic fibers are well known to the expert and are further explained in detail.

Fastening binding threads of high strength can be obtained from different modes. For example, when one or more fibers of the mounting binding thread at least contains one compound, that consists at least one, preferably two or more elements from the group of C, Si, N, B, Al, Zr, Ti, W.

Especially affixing binder threads with high load-bearing capacity, which may include, for example, ceramic fibers, may be obtained if the sum of the concentrations of C, SI, B, N, Al, ZR, TI, W is more than 50% wt., preferably more than 83 wt. % preferred more than 85% wt., especially more than 95% of the total weight of the affixing binder thread, with the content of one or more of C, SI, B, N, Al, ZR, TI, W 0% wt. The affixing binder thread can therefore only have a content of one, preferably two or more of C, SI, B, N, Al, ZR, TI, W. The affixing binder thread can therefore be a content of one, preferably two or more from C, Si, B, N, Al, Zr, Ti, W. An affixing binder thread may include glass fiber or it consists of preferably not more than 15% by wt. of it, preferably not more than 10% by wt. of glass fiber(s) based on the total weight of the affixing binder thread. That means, in particular, there is no fiber glass included in an affixing binder thread.

If the situation demands, we can modify its way of creation. It can be used in the installation of the multiple affixing binder threads, which may include the same or different fibers.

Preferably an affixing binder thread includes at least 15% by wt. fiber(s) selected from the group consisting of carbon fiber, carbon fiber-precursor fibers, ceramic fibers and their mixtures, based on the total weight of the affixing binder thread. To have an affixing binder thread a very good rating, it may be advantageous that the affixing binder thread is at least 75% by wt., preferably at least 85% by wt., preferably at least 96% by wt. more particularly at least 98% by wt., more precisely 99% by wt. or completely of fiber(s) selected from the group consisting of carbon fiber-precursor fibers, ceramic fibers, carbon fibers and their mixtures, based on the total weight of the affixing binder thread.

As affixing binder threads, for example can be of 1K-filaments, yarns, especially carbon yarns with low weight per meter, can be used. They range from 0.05 to 0.12 g/m. or carbon fiber-spun yarn with a low weight per meter. Another way is a range of 0.04 tex to 1 tex can be used. These are selected according to the situation.

As optional, components can be affixing binder thread too. For example, any expert based on his general knowledge can select organic polymers such as polyacrylnitrile. These are the polymers which are present in the form of fibers as well as metals. They are coming in the form of metal thread-yarns of additives. An expert may select such optional ingredients based on his general knowledge and the teachings of these descriptions. However, guidance will be given in the beginning.

An affixing binder thread has a linear density of not more than 1 Tex, or preferably a linear density in the range of 0.04 to 1 Tex, or preferably a linear density in the range of 0.04 to 0.75 Tex, determined in accordance with DIN 60905.

This invention provides a particular advantage. The affixing binder thread can be used, which by complete heating or substantially completely to carbon compounds and/or mixed or compounds containing two or more from C, Si, N, B, Al, Zr, Ti, W. It can be preferably mixtures or compounds that contain silicon and carbon that can be converted/transformed. This is a different form. For example after heating at a temperature of 1000° C. for one hour under 99.9% by wt. nitrogen in comprehensive atmosphere (based on the total weight of the atmosphere), the weight can change. The residual material in which the total contents is consists of C, Si, N, B, Al, Zr, Ti and W. They may be of carbon and silicon and with a weight of at least 90%. The 93% by wt. can be based on the total weight after heating residual affixing binder thread. In that case, the content of one or more of C, Si, N, B, Al, Zr, Ti, W can be 0% by wt. Thus the weight change happens according to the compounds and mixtures. Heat is also affecting it.

Affixing binder thread may be used specially as a high temperature resistant binder thread. The term “high temperature resistant binder thread” carries many meanings according to the usage of the compound. It is used in the present invention which includes any thread of material. The exposure of the thread to a temperature of 405° C. under a 99.9% by wt. nitrogen comprehensive atmosphere may change its nature and activity. It is based on the total weight of the atmosphere. The pressure given from outside is also influencing it. A period of 8 hours projects the compound without completely melting it or to decompose it completely. The form decomposed residue without fibers formation, for example is the powder form. Preferably, it can be used in high mass high temperature refractory binder thread also. Any thread can be used like this. It can be obtained by an exposure to a temperature of 410° C. under a 99.9% by wt. nitrogen comprehensive atmosphere over a period of 8 hours. A weight loss of no more 60% by wt. occurs at that particular activity time. It is based on the total weight of the thread before heating.

Again it can be used in a very high mass high temperature resistant binder threads. Just like before, it can be any thread which is obtained from an exposure to a temperature of 600° C. under a 99.9% by wt. nitrogen comprehensive atmosphere. It is based on the total weight of the atmosphere while over a period of 8 hours a weight loss of no more than 60% by wt. The total weight of the threads before heating will change after heating. The more suitable compound can be used with a particular high mass high temperature resistant binder threads. It can be any thread that is obtained from an exposure to a temperature of 900° C. under a 99.9% by wt. nitrogen comprehensive atmosphere based on the total weight of the atmosphere. During the activity, over a period of 8 hours, a weight loss of no more than 60% by wt. is happening. It is based on the total weight of the threads before heating. Notably, an extremely high temperature resistant binder thread can be used, i.e. any thread that is obtained from an exposure to a temperature of 2000° C. under atmosphere comprising 99.9% wt. nitrogen based on the total weight of the atmosphere and which does not display a mass loss of more than 60% over a period of 8 hours, based on the total weight of the thread before heating. The 99.9% by wt nitrogen atmosphere is subject to extensive contamination with the content of not more than 0.01% by wt., based on the total weight of the atmosphere. It may comprise nitrogen, noble gases, oxygen and carbon oxides and another set of nitrogen and noble gases together.

A very rare and advantageous novel form of fiber layer and composite materials can be obtained when used as an affixing binder thread that after heating at a temperature of 400° C. It can be occurred at preferably 410° C., 600° C. and at 900° C.; it can happen especially at 2000° C. too. That is also under a 99.9% by wt. nitrogen comprehensive atmosphere, based on the total weight of the atmosphere, especially after a heating period of 8 hours at this temperature. In this situation, it will show a tensile strength of at least 5 MPa, preferably at least 10 MPa and 120 MPa. It can be preferred 200 MPa too, especially another preferred 400 MPa. The tensile strength can be determined according to ASTM D3379-75. Moreover, in the method section, a preferred method for detecting the tensile strength is explained in detail.

Surprisingly, it was evident in many trials which led to the present invention for producing the fiber clutch using affixing binder thread either before or even after heating that is used in the production of the composite material temperatures, a satisfactory tensile strength. Especially surprising and advantageous is the fact that by using an affixing binder thread made of or including precursor fibers of carbon fibers, e.g. pre-oxidized polyacrylnitrile (PAN-Ox), the tensile strength increases, when heated at temperatures of up to 2000° C. or more. Affixing binder threads with one or more fibers selected from the group is consisting of precursor fibers from carbon fibers or their mixtures. They lead to this invention of fiber clutch and composite materials with excellent material properties.

In addition to affixing binder thread, an optional supplementary binding thread can be used. Any expert can use a known material to produce this, for example, on the basis of a thread from polyacrlynitrile. Possibly, for example, a section with fastening, particularly those based on heating—resilient material and one or more sections are fitted with a supplementary binding thread. The term “binding thread” as used below includes both affixing binder thread, as well as complement binding threads.

A binding thread may be, for example, a yarn, especially a yarn according to DIN 60900. The yarn may include one or more fibers and any expert can show yarn construction. It may be advantageous for example when the thread includes at least two counter-twisted yarns, since such a thread can be compressed to a lesser extent, particularly when the fiber layer is used to form a composite. In addition, it can be a binding thread around one or more multi-filament strands, multi-filament strand. It may have fineness in the range of 0.04 to 1 Tex. Otherwise, it may have a fineness ranging from 0.04 to 0.75 Tex, determined according to DIN 60905.

In addition, both staple, and filament yarn or their mixtures as a string, both are used as an affixing binder thread, and as a complement binding threads.

The term “staple yarn,” as used in the present invention refers to yarn from the finite-length, for example 1 to 50 mm, preferable 6 to 20 mm, preferably 8 to 15 mm long fibers is constructed. Some examples of these fibers of any length are obtained by twisting a plurality of fibers by spinning a yarn. The term “filament yarn”, as used in the context of the present invention refers to yarn from theoretically infinitely long fibers, called filaments, is constructed.

In addition an affixing binder thread can be close to a yarn that contains the carbon fiber(s) and/or carbon-precursor fiber(s) and/or ceramic fiber(s), optionally a yarn on the basis of another material content. For example, the yarn includes an organic polymer, in particular polyacrylnitrile or rayon. Furthermore, an affixing binder thread in combination with an adjacent running or with the affixing binder thread an additional binding thread is twisted. Also combinations of two or more affixing binder threads are possible. These depend upon different nature of threads.

Fastening at least one fiber layer on one or more additional fiber layers with an affixing binder thread is carried out by passing the affixing binder thread through at least a fiber layer and one or more other fiber layers.

The passage of the affixing binder thread can result through various procedures well known to an expert, for example, by sewing methods and/or knitting procedures and/or crocheting. These procedures can be adapted properly by an expert on the basis of his general knowledge of the invention.

In some applications it may be advantageous for the affixing binder thread to pass through gaps or spaces in the fiber layer, for example to run in between the filaments. Preferably, however, the affixing binder thread is passed through the fiber layer, for example by piercing it, for example with a needle.

It is very advantageous if the fastening is done by sewing at least one fiber layer on one or more additional fiber layers. This is a very safe and reliable way, and can be achieved in highly reliable connection of the respective fiber layers.

Sewing with industrial sewing machine can be selected by an expert on the basis of his general knowledge. After that, the teachings of the present invention can be made for the real enthusiasts. Needle and stitch types can be selected by an expert on the basis of his general knowledge. A stitch can be performed unilaterally or bilaterally. In sewing, under use of a waiter thread and a lower thread, that is one essentially under the fiber layer and one over the fiber layer, that is substantially below the fiber at least one of them, preferably both can be an affixing binder thread.

According to the affixing step, the affixing binder thread enters the first fiber layer at the first entry point, is fed through the first fiber layer and at least another fiber layer, and leaves at its first exit point on at least another fiber layer. Optionally, it enters through a second entry point on at least another fiber layer, is fed through at least another fiber layer and the first fiber layer and leaves at a second exit point on the first fiber layer.

Further optionally, the attachment binding thread at a third entry point to the first fiber layer is entered again through the first fiber layer and is passed through at least one other fiber layer and emerge at a third exit point on at least one additional fiber layer and in a fourth entry point on one more fiber layer and enter through at least one additional fiber layer and the first fiber layer is to be passed and emerged at a fourth point of exit on the first fiber layer. This above described process of performing the binding thread attachment can be repeated several times.

Preferably with some attachment process one or preferably every other point of exit, such as the first, third, fifth can escape, and the subsequent entry point coincides spatially for example, the second, fourth, sixth entry site, or have a distance of less than 3 mm. The entry and exit points on a fiber layer may also be at least partially spatially separated in each case.

In the finished fiber layer there can be a point of entry, such as the first entry point, and the corresponding exit point, for example the first exit point, substantially perpendicular to each other; preferably they are offset by less than 5 mm. However, in some affixing procedures, the affixing binder thread is passed through the fiber layer at an angle, so that an entry point and the corresponding exit point do not essentially lie in a vertical line.

One area of the fiber scrim, which extends between the inlet and outlet points of a mounting binding thread is called in the context of the present invention as a mounting portion, and in case of fitting them by sewing, is described as a seam.

Furthermore, a mounting binding thread, before applying at least partially, preferably completely, is surrounded by a mounting fluid such as black wash/cinder paste. Without the present invention that would be limited to the accuracy of the following assumption is assumed that the partial or complete encapsulation of the mounting binding thread with a mounting fluid to help the fixing of sheets with a high temperature resistant and therefore comparatively as sensitive and/or brittle material as continue to carry out the increased speed. This allows a working and production time saving, so that the fiber layer and thus fiber scrim-reinforced composite materials for consumers can be provided cost-effectively.

A mounting fluid for example can be provided in the form of a liquid, a solution, a suspension, a fluid mixture or aerosol.

For example, the mounting fluid includes or consists of one or several compounds selected from the group consisting of, water, silicone oils, polyurethanes, epoxy resin compounds, such as epoxy, polyvinyl alcohols, waxes, fatty acid, polyurethane esters, Polyurethanes, derived derivatives, and mixtures thereof. In addition, the mounting fluid optionally comprises solvents, such as inorganic or organic solvents, bases, acids, buffer mixtures, lubrication medium, dispersing agents and other optional components that a skilled person may generally choose with his specialist knowledge and the teaching of the present invention. Preferably, in the mounting fluid is a watery mixture.

In order to reach high degree resilient mounting, it may be advantageous in that a mounting portion, such as a suture, obliquely or substantially perpendicular, i.e. at an angle of at least 10°, preferably at least 30°, preferably about 80° to 90°, extends to an edge, preferably the running in the longitudinal direction of the fiber scrim longitudinal edge of the fiber structure.

A mounting portion, for example, a seam can be produced over its entire length from mounting the thread or complement binding thread or optionally have at least a portion that is used in the place of a mounting binding thread, a supplementary binder thread or no binding thread.

Advantageous for the production of a fiber scrim, it may be a fitting thread binding and complement binding thread in a weight ratio of 20:1 to 1:30, preferably 3:1 to 1:15, preferably 2:1 to 1:7, based on the total weight of mounting tie threads and additional binding threads, which are present for use in the fiber layer.

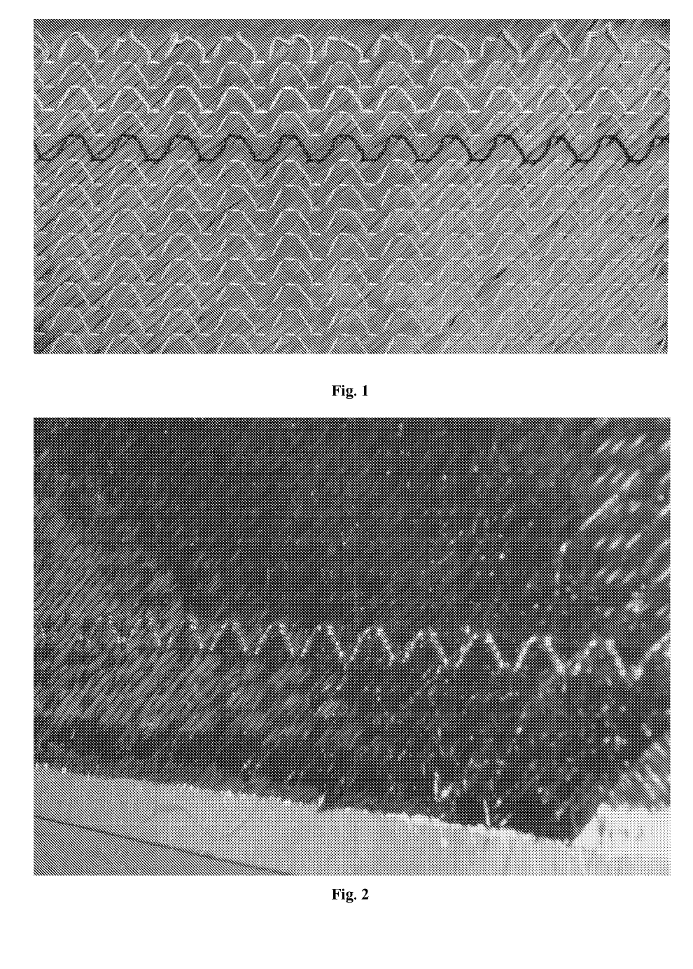

A possible advantageous arrangement of mounting thread binding and complement binding thread is shown in FIG. 1, which follows a mounting portion (seam) from attaching several tie thread attachment portions (groove) in addition to binding thread.

Attaching sections of three-thread attachment and mounting sections of complement binding thread on the basis of the common general knowledge in the light of the teachings of the present invention can be arranged in numerous ways, for example, and also can intersect or overlap. In many applications it may be advantageous if one or more attachment portions of Attachment binding thread installation of additional binding thread sections extend substantially parallel to each other.

After attaching the at least one additional fibrous layer on the first fiber layer with a mounting binding thread a fiber layer is recovered. Preferably, it can be a multi-axial fiber layer. The term “multi-axial fiber layer,” as used in the present invention describes a fiber layer that comprises at least two unidirectional layers (also called device layers); their respective longitudinal directions are not parallel to one another. A process for preparing unidirectional layers is well known and is also explained in detail below.

In the next step, the fiber layer is subjected to a high temperature treatment in order to obtain a fiber layer, the advantageous properties as reinforcement in composite materials. During such high temperature treatment, for example, carbonization or graphitization of carbon fibers or their precursor fibers, which are present in fiber layers and/or in a binder thread, can occur. Fiber layers and/or binding threads, or strands of fiber layers, which may consist of carbon fiber(s) or their precursor fiber(s) exist, after such treatment have a carbon content higher than 90 wt. %, preferably more than 92 wt. %, preferably from 95 wt. % or more, based on the total weight of the fiber layer, and have the connective thread or sub-region of the fiber layers.

The temperature treatment of the fiber scrim may, at a minimum temperature of 400° C., preferably 405° C. to 2700° C., preferably 500° C. to 2500° C., more preferably 600° C. to 2000° C., especially 600° C. to 900° C. and/or 1600° C. to 2000° C., be carried out under an inert atmosphere.

The term “inert atmosphere” in the context of the present invention includes any atmosphere that is free of oxygen or an oxygen content of less than 5 wt. %, preferably less than 1 wt. %, preferably less than 0.2 wt. %, more preferably less than 0.1 wt. %, especially less than 0.001 wt. %, based on the total weight of the atmosphere has. A preferred inert atmosphere has, for example, a content of at least 99.9% of nitrogen and/or inert gas (it), based on the total weight of the atmosphere. The atmosphere at a grade of at least 99.9% by weight of nitrogen and/or inert gas (it) is subject to contamination with a content of not more than 0.01 wt. %, based on the total weight of the atmosphere, preferably continued from nitrogen, noble gases, oxygen, and carbon oxides, preferably of nitrogen and noble gases. Moreover, as “inert atmosphere” and an atmosphere are used, which has a pressure of less than 1 atm, i.e. an atmosphere, which was following a partial or complete evacuation of the atmosphere-comprising container obtained. The inert atmosphere may advantageously include nitrogen and/or noble gases.

The high temperature treatment period may vary, for example at least 5 minutes, preferably 1 hour to 24 hours, preferably 2.5 to 12 hours, especially last from 3.5 to 9 hours.

After completion of the high-temperature treatment, a high-temperature treated fiber layer is recovered. In this fiber lay the fiber layers that are at least partially still attached to each other with a mounting thread.

In a further subsequent step of the process, the high-temperature fiber layer treated with a binder to be impregnated, with an impregnated fiber layer is first obtained the impregnation is not yet cured. This impregnated fiber layer is referred to in the present invention as a pre-preg.

The binder may include one or more resins and/or one or more inorganic impregnating agents include, and one or more solvents such as water, as well as graphite and/or soot, and other additives which an expert based on his general knowledge and the teaching of the present description can be chosen.

Resins, which are particularly suitable for impregnation of bonded structures are for example phenolic resins, epoxy resins, benzoxazine resins, cyanate ester resins, Polyester-/Vinylester-Harze, furan resins, polyimide, polyacrylate, their derivatives and derivatives mixtures thereof.

To impregnate the scrim fiber also can be used inorganic impregnating agent, with the impregnation of bonded structures such as liquid silicon, SiC precursor polymers, especially silazanes, SiC precursor oligomers and their mixtures are particularly difficult.

The term “SiC precursor polymer” as it is used in the present invention describes any compound with a molecular mass greater than about 300 g/mol, and that contains silicon as well as carbon and/or nitrogen, and has, for example, a content from 10 to 99 wt. % of Si with respect to the total weight of the compound. The term “SiC precursor oligomer”, as it is used in the present invention, describes any compound containing silicon as well as carbon and/or nitrogen, with at least two silicon atoms, a molecular mass of up to and including 300 g/mol, and has, for example, a content from 10 to 99 wt. % of Si with respect to the total weight of the compound. Preferably, an SiC precursor polymer or an SiC precursor oligomer converts at least partially into SiC on heating to a temperature higher than 150° C. under an inert atmosphere.

On impregnation of fiber fabrics, for example, very good results are obtained when at least one compound is selected from the group consisting of oligosilazanes, polysilazanes oligocarbosilazanes, polycarbosilazanes, oligosilanes, polysilanes, oligoborocarbosilazanes, polyborocarbosilazanes, methyl oligosiloxanes, methyl polysiloxanes, oligocarbosilanes, polycarbosilanes, oligoborosilazanes, polyborosilazanes, oligo (dialkyl) silicones, poly (dialkyl) silicones, oligosiloxanes, polysiloxanes for example poly (dialkyl) siloxanes, such as poly (dimethyl) siloxanes, for example poly (diaryl) siloxanes such as poly (diphenyl) siloxanes, such as poly (monoalkyl-monoaryl) siloxanes, such as poly (mono methyl monophenyl) siloxanes, their derivatives and mixtures thereof. The terms oligosilazanes, oligocarbosilazanes, oligosilanes, oligoborocarbosilazanes, methyl oligosiloxanes, oligocarbosilanes, oligoborosilazanes, oligo (dialkyl) silicones, oligosiloxanes, etc. include any oligomers covered by the respective term and composed of at least two monomer units, which means any oligomer, starting from a dimer up to compounds having a molecular weight up to and including about 300 g/mol.

The terms polysilazanes polycarbosilazanes, polysilanes, polyborocarbosilazanes, methyl polysiloxanes, polycarbosilanes polyborosilazanes, poly (dialkyl) silicones, polysiloxanes etc. include any polymers covered by the respective term having a molecular weight of more than about 300 g/mol.

A fiber fabric may also be impregnated with both inorganic impregnating agents, as well as with resins, preferably synthetic resins. For example, adjacent sections of a fiber fabric may be impregnated with one or more inorganic impregnating agents and/or with one or more resins. For example, impregnation may also be performed in several layers or in a sequence of impregnation processes with one or more inorganic impregnating agents and/or with one or more resins, and/or impregnation performed using mixtures of one or more inorganic impregnating agents and resins. The choice of the curing conditions takes into account the requirements of the selected impregnating agent.

In a further procedural step, curing of the impregnated fiber fabric may be performed in such a way as to give a cured fiber-fabric-reinforced composite material, in particular, a composite material that at least partially has a fiber-fabric-reinforced matrix. If the impregnation is performed at least partially or completely using one or more organic resins, a matrix including or consisting of cured plastic is obtained after curing, and where the composite so obtained is commonly referred to as fiber-reinforced plastic. In the case of a carbon fiber fabric or a fabric that contains carbon fiber at least in part, a carbon fiber-reinforced plastic (CFRP) is obtained. In the case of impregnation with one or more inorganic impregnating agents, a matrix of at least partially cross-linked, inorganic impregnating agent is obtained after curing.

The curing of the impregnated fiber fabric may be preferably in a curing temperature range of at least 40° C., at a curing temperature range from 50 to 260° C., preferably 80 to 200° C. The curing may be performed under pressure, preferably before and/or at least during part of the curing period, for example by pressing at least a portion of the surface of at least one surface of the impregnated fiber fabric using a pressing tool. The curing period, for example, may be at least 1 minute, preferably between 10 minutes and 8 hours, preferably between 15 minutes and 3 hours. The period of curing under pressure may, for example, be in the range of 1 minute, preferably between 10 minutes and 8 hours, preferably between 15 minutes and 3 hours. The pressing power may, for example, be at least 0.01 MPa, preferably 0.01 MPa to 100 MPa.

The content of binder with respect to the total weight of the non-impregnated fiber fabric may lie in a range from 10-90 wt. %, preferably from 30 to 70 wt. %, preferably from 35 to 50 wt. %. The content of resin and/or inorganic impregnating agent with respect to the total weight of the non-impregnated fiber fabric may lie in a range from 5 to 85 wt. %, preferably from 25 to 65 wt. %, preferably 30 to 45%.

The fiber fabric may be impregnated, for example, to saturation of the fiber fabric. In particular, liquid resins or hot melt resin may be used, for example, phenolic resins.

The procedural step of impregnation and curing may be performed using methods known to any person skilled in the art. Very advantageous results are obtained when the impregnation is performed through immersion in a bath or using a film transfer process. For example, these steps may be performed continuously, i.e. the fabric may for example be unwound from a roll, fed through one or more furnaces at a suitable temperature and atmosphere, for example, 400° C. or more under an inert atmosphere, and then further guided through a resin bath and/or a bath with inorganic impregnating agents, and/or a calendar roll and/or other impregnating device. In addition, curing may be performed to give a composite material whose matrix is reinforced by a fiber fabric, for example, a carbon fiber fabric. The step of curing may be performed either continuously or intermittently. The cured resin and/or the cured inorganic impregnating agent serves multiple functions in the composite material obtained after curing. To begin with, the resin creates links between the warp and weft of the fiber fabric and fixes its position in the fabric. Depending on the composite application, the fiber fabric may be completely or partially embedded by sections in a matrix comprising cured resin and/or inorganic impregnating agent, and/or fully or partially covered by individual fibers only covered by a film of resin and/or inorganic impregnating agent and/or be partially free of resin. The cured binder also offers a mechanical reinforcement of the fiber structure.

After the curing and/or pressing step, a fiber-fabric-reinforced composite material or a fiber-fabric-reinforced composite product is obtained.

As a fiber-fabric-reinforced composite material product in the context of the present application refers to a partially or preferably fully cured fiber-fabric-reinforced composite material, the optional further procedural steps such as cutting, shaping, etc, may be performed. In the present application, a cured fiber-fabric-reinforced composite material is also referred to as a green body.

Optionally, the partially or fully cured fiber-fabric-reinforced composite material may undergo further processing steps such as, among other possibilities, thermal treatment, for example, carbonization or graphitization, or more comprehensive heating and/or pressing, with or without the intervening step of obtaining the partially or fully cured fiber-fabric-reinforced composite material product.

In a further procedural step, thermal treatment may be performed to give partial or complete carbonization and/or graphitization of the cured binder. This procedural step may generally be performed by any person skilled in the art by means of the known method for this and that is hereinafter referred to as “binder matrix carbonization” or “binder matrix graphitization.” The term “partial or complete carbonization (graphitization) of the cured binder” as used in the present invention demonstrates that the content of carbon in a composite material sample subjected to thermal treatment of partial or complete carbonization (graphitization) increases when compared with that of the composite material sample before thermal treatment.

Thermal treatment may be performed in a first temperature range (often referred to as “carbonization”) and may, for example, be performed by heating with the exclusion of substances causing oxidizing action, either under an inert atmosphere, inert gas or by wrapping the sample to be burned in a lattice of the oxidizing media, especially of an oxygen-binding substance, at a temperature or in a temperature range from about 800° C. to about 1250° C., preferably from 850° C. to 950° C., in particular from 880° C. to 920° C. The thermal treatment in the first temperature range may be performed during a period of, for example, at least 30 minutes, preferably at least 8 hours, preferably 30 minutes to 96 hours. The term “inert atmosphere” has been explained above. For the thermal treatment in a first temperature range (“carbonization”) in accordance with any of the teachings of the present invention, any methods known to a person skilled in the art such as a fixed phase pyrolysis may be used. In order to achieve good coke yield, a first heating phase may be initiated, for example, with a relatively low temperature gradient in the range of 300 to 600° C. at a maximum of 4° C. per hour, or it may be carbonized under pressure. The final temperature in this procedural step must not exceed 1250° C., for example.

Both fully as well as a partially cured fiber-fabric-reinforced composite materials may be subjected to thermal treatment in a first temperature range.

After thermal treatment in the first temperature range, a composite material is obtained whose matrix comprises carbon that is reinforced with a carbon fiber fabric (carbon fiber reinforced carbon, CFRC).

As an alternative to the thermal treatment in the first temperature range or in addition to it, an addition thermal treatment, especially afterwards, is performed in a second temperature range (often also referred to as “graphitization”). The thermal-treatment in a second temperature range (“graphitization”) may generally be performed by any person skilled in the art by means of the known method for this. In particular, heating can take place in an inert atmosphere at a temperature of about 1251° C. to 3000° C., preferably of 1800° C. to 2200° C. for a period of, for example, at least 30 minutes, preferably at least 8 hours, especially from 30 minutes to 96 hours. The term “inert atmosphere” has been explained above.

In the case of thermal treatment in the first and/or second temperature range, the resin layer shrinks as a result of the weight lost by the elimination of volatile components. The composite material obtained after the thermal treatment is characterized by a high temperature resistance.

After the thermal treatment of the fiber-fabric-reinforced composite material or composite material product, heat-treated fiber-fabric-reinforced composite material or composite material product(s) may be obtained. Optional processing steps may be performed, for example, cutting or shaping, etc.

Optionally, the composite material, particularly a composite material comprising carbon fiber-reinforced carbon material, obtained from one or more thermal treatments in a first or second temperature range, may be subjected in addition to one or more post-treatments, particularly compaction, where the composite material is impregnated at least once, especially with a carbonizable agent, and/or at least once again thermal treatment in a first or second temperature range (which is usually referred to as post-burn). The compaction, in particular the steps of impregnation and thermal treatment, may generally be performed in accordance with the teaching of the present invention by any person skilled in the art by means of the known method for this. The concept of compaction, as used in the context of the present invention, refers to any treatment of a material or workpiece that leads to maintaining or increasing the density of the treated material or workpiece. Preferably, such compaction treatment may increase the density. The impregnation and thermal treatment may be carried out particularly advantageously under the conditions described above and below. For the impregnation, for example, the so-called vacuum-pressure method may be used.

For impregnating parts that contain or consist of carbon, the impregnating agent may be of any known materials such as fabrics with a coke yield of more than 30 percent by weight, for example synthetic resins, especially thermosetting resins or pitches and the associated derivatives, and mixtures of resins and pitches and/or pitch derivatives. In particular, phenolic resins of the Novolac or Resol type, furan resin or impregnating pitch are used. Thermal treatment in a first and/or second temperature range, as defined above, after impregnation, the so-called post-burn, takes place with the exclusion of substances causing oxidization, especially under an inert atmosphere. Before and/or after thermal treatment in a first and/or second temperature range, heating or cooling is performed for, for example, 8 to 10 hours, for example at room temperature (20° C.). The preferred periods of time and temperature ranges for thermal treatment in a first or second temperature range are explained in detail in the example above. In this procedural step, one or more additional carbon material covers should be applied to the existing cover in order to fill the cracks and pores in the first cover resulting from the first carbonization. This impregnation and post-burn process may also be repeated preferably 1 to 3 times depending on the intended protective effect for the fibers.

For specific applications, it may be advantageous to optimize the composite material by means of a thermal treatment in a first temperature range in which carbonization takes place, then by thermal treatment in a second temperature range under an inert atmosphere, in which graphitization takes place. The implementation of such a measure is, however, quite optional. In most cases, the final temperature of 3000° C., in particular 2400° C. for graphitization, is not exceeded. Preferably this is performed at temperatures of 1800 to 2200° C. For this step, all known graphitization methods may be used.

The above-described compaction that comprises an initial impregnation and then a combustion process may be repeated one or more times.

The number of compactions needing to be performed depends on the desired target density of carbon fiber-reinforced carbon fiber ceramic, and may be performed one or more times, for example two, three or four times or more, preferably in an immediately consecutive manner. Preferably, the steps of impregnation and subsequent burning are each performed three times. After compaction, for example, densities from 1.30 to 1.60 g/cm³, preferably from 1.30-1.55 g/cm³, are achieved.

Furthermore and optionally, the fiber-fabric-reinforced carbon composite material obtained from one or more thermal treatments and/or also compacted as explained above may also be provided with protective coatings made of refractory materials such as pyrolytic carbon, TiC, TiN or SiC in addition to a gas phase coating by the CVD process (CVD=Chemical Vapor Deposition) or after the CVI process (CVI, chemical vapor infiltration). In the context of the above invention, any person skilled in the art knows the application of the CVD/CVI method. CVD/CVI methods are taught, for example, in DE 39 33 039 A1 or in the publication of E. Fitzer et. al., Chemie-Ingenieur-Technik 57, No. 9, p. 737-746 (1985).

In addition and optionally, the carbon fiber-fabric-reinforced carbon composite material obtained after thermal treatment in a first or second temperature range and/or also compacted as explained above, and/or also coated by the CVD process or by the CVI process may undergo siliconization. Such a process is taught, for example, in the publication of E. Fitzer et. al., Chemie-Ingenieur-Technik 57, No. 9, p. 737-746 (1985).

Siliconization in the context of the present invention is performed in a method known to any person skilled in the art. Composite materials, especially of high quality, may be obtained, for example, when the silicon is in the temperature range from 1450° C. to 2200° C., preferably in a temperature range from 1650° C. to 1750° C. under an inert atmosphere. In particular, processing may be performed under vacuum in the temperature range of 1650° C. to 1750° C. After reaching the siliconization temperature, the time required for infiltration of and reaction to SiC requires at least 10 minutes, for example 10 minutes to 1 hour. In the case of a siliconization without using a vacuum, siliconization may be achieved under an inert atmosphere at temperatures of 2100° C. to 2200° C. The sum of infiltration and reaction time may also amount to at least 10 minutes, for example between 10 minutes to an hour, in the case of siliconization even without the use of vacuum. Advantageously, the above-described siliconization may be performed using the so-called wick technique. In this method, the bodies to be siliconized lie on porous, very absorbent carbon bodies compared to the silicon, and whose lower part is immersed in liquid silicon. The silicon then rises through this wick to the bodies to be siliconized without the latter having a direct connection with the silicon bath.

The above-described steps of the compaction, particularly through impregnation and optional subsequent thermal treatment in a first or second temperature range, the siliconization and the gas phase coating may be repeated one or more times and be combined in any order.

Composite materials of a particularly high quality may, for example, be obtained if, following the step of curing and optional pressing of the impregnated fiber fabric and thermal treatment within the first temperature range at which there may be carbonization, the previously described steps of impregnation and thermal treatment in a first and/or second temperature range by means of which compaction is achieved, may be repeated at least once, preferably one to three times, preferably three times. As an option and in addition, siliconization or a gas phase coating or siliconization may be followed by a gas-phase coating. The gas phase coating may be obtained using carbon or mixtures containing carbon using a CVD or CVI process as described above.

In a further aspect, the present invention provides a fiber fabric that is obtainable by a process consisting of: a) preparing an arrangement of two or more fiber layers that are partially or completely disposed one on top of the other, wherein one or more fiber layers of at least 50 wt. % fibers selected from the group consisting of carbon fibers, precursor fibers of carbon fibers, ceramic fibers and mixtures thereof, affixing at least one fiber layer onto one or more additional fiber layers using an affixing binder thread, wherein the affixing requires that the binder thread passes through at least one fiber layer and at least one of the said one or more additional fiber layers, wherein the fixing binding thread comprises one or more fibers selected from the group consisting of carbon fibers, precursor fibers of carbon fibers, ceramic fibers and mixtures thereof, and b) high-temperature treatment of the fiber fabric at a temperature of at least 400° C. under an inert atmosphere for a high temperature treatment period.

In a further aspect, the present invention provides for the use of a fiber-fabric-reinforced composite material in accordance with the invention or a composite material product and/or a fiber-fabric-reinforced composite material or composite material product thermally treated in accordance with the invention and/or compacted and/or siliconized and/or gas-phase-coated fiber fabric-reinforced composite material or composite product in accordance with the invention or a fiber fabric in accordance with the invention for the production of furnaces, particularly high-temperature furnaces, for heating the heating chamber to temperatures of, for example, at least 800° C., preferably at least 1100°, especially at least 2000° C., especially for the production of inner cladding or hot region cladding of such furnaces for the production of heat conductors, the production of chemical reaction apparatus, the production of components for chemical reaction apparatus, and for producing hot extrusion dies.

Very advantageous products that include or consist of the fiber-fabric-reinforced composite material and/or thermally treated and/or compacted and/or siliconized and/or gas-phase-coated fiber-fabric-reinforced composite material in accordance with the invention, include, among others, high temperature resistance elements and devices such as furnaces, the inner cladding or hot region cladding, heat conductors, chemical reaction apparatus, components for chemical reaction apparatus, and hot extrusion dies.

A fiber layer that is very advantageous because it results in a very regular fiber fabric is referred to as unidirectional fiber.

To produce a unidirectional layer, one or more fibers are used and are spread out to form a unidirectional strip. The unidirectional strips may be arranged next to each other to form a unidirectional weave. The unidirectional strips may thus be positioned to be immediately adjacent to one another, to be at a distance from one another or to overlap one another. The term “fiber,” as used in the present invention includes fibers of any materials selected by a person skilled in the art.

Fiber fabrics offering very advantageous properties may be obtained, for example, when at least one fiber layer, especially having a unidirectional orientation (and preferably all fiber layers), contains a number of filaments in the range of 0.5 K (500 filaments) up to 500 K (500,000 filaments). Preferably, the number of filaments of a fiber layer having a unidirectional orientation is in a range of 1K (1,000 filaments) to 400 K (400,000 filaments), preferably in a range from 12 K (12,000 filaments) up to 60 K (60,000 filaments). The method according to the invention therefore allows both the use of fibers of a light type (“low tow” in a range of about up to 25 K), as well as the use of fibers of a heavy type (“heavy tow” in a range of about 25 K). An extremely cost-effective production of a fiber layer having a unidirectional orientation may be obtained when using fibers with a number of filaments of more than about 24 K. In addition and optionally, only one part of a fiber may be spread out, for example, with only half the number of filaments of a fiber.

The diameter of the filaments of at least one fiber layer having a unidirectional orientation, preferably all fiber layers having a unidirectional orientation, may be in a range, for example, of 6-8 microns.

In addition, a single fiber layer having a unidirectional orientation may have an area-related weight in a range, for example, from 50 g/m2 to 500 g/m2, preferably in a range from 150 g/m2 to 350 g/m2. Depending on the desired end product, it may be advantageous to select one or more unidirectional fiber layers with an area-related weight of at least 305 g/m2.

In the case of the use of carbon fiber and/or its precursor fibers, both fibers that were obtained based on polyacrylonitrile as well as those based on pitch or phenolic resin fibers give a fiber layer very good mechanical strength.

Fiber fabrics can, in principle, be produced according to any methods known by a person skilled in the art. Fiber fabrics with very advantageous properties are fiber fabrics that include or consist of at least one fiber layer, especially having unidirectional orientation, preferably all fiber layers, especially unidirectional layers of carbon fiber and/or its precursor fibers and/or ceramic fibers, wherein these fiber fabrics may have a number of filaments per fiber layer having unidirectional orientation in a range of 1K (1,000 filaments) to 400 K (400,000 filaments) or more, preferably, in a range from 12 K (12,000 filaments) to 60 K (60,000 filaments).

Fiber fabrics with advantageous material properties and relatively low manufacturing costs may be obtained when one or more fiber layers, especially having unidirectional orientation, are used and that include polymer fibers, especially organic polymer fibers, or mixtures thereof. In some applications, it may prove to be advantageous to use fibers based on polyacrylonitrile, fibers based on viscose, in order to produce at least one fiber layer. One, two, three or more of the fiber layers may consist, for example, completely or at least 80 wt. % of polyacrylonitrile and/or viscose fibers, based on the total weight of fibers in the fiber layer.

Before, during and/or after spreading a fiber layer having unidirectional orientation, the starting material(s) may optionally be treated with one or more chemical binders. This can be achieved by spraying the binder, by dipping into bath containing the binder, or by spraying a warm meltable or warm adhesive polymer. When using a fiber layer that is formed from non-contiguous filaments, a person skilled in the art may, if desired, subject the filaments to a mixing and, for example, expose a fiber layer having unidirectional orientation to a pressure water jet or perform needling before spreading. To produce a fiber layer having unidirectional orientation, fibers may be spread out individually and the resulting unidirectional strips may optionally be laid out adjacent to each other to form a fiber layer having unidirectional orientation. The spreading of one or more fibers may be performed using any method known to a person skilled in the art who can also adapt and change the method based on the teachings of the present invention.

The method according to the invention enables in particular the production of a multi-axial fiber fabric, wherein two or more unidirectional layers may be arranged on top of one another.

The approach to the spreading of the fibers and the production of unidirectional layers and bonded structures as well as the preparation of multi-axial fiber fabrics are outlined below and are also, for example, described in the publications FR A 2 581 085 and FR A 2 581 086.

Fiber fabrics with various material properties may be obtained by producing fiber fabrics having two, three, four, five, six, seven, eight or more fiber layers as desired and/or unidirectional layers. To achieve a high degree of resilient material, it may be advantageous that a unidirectional layer is arranged in another longitudinal direction to that of the unidirectional layer above and/or below the said unidirectional layer. Preferably, all unidirectional layers in a fiber fabric will be arranged to extend in a different longitudinal direction. It may be advantageous in this case when at least the longitudinal direction of a unidirectional layer is arranged at an angle of at least 30°, preferably at least 45°, preferably at least 60°, especially 85-90° to the longitudinal direction of at least one subsequent unidirectional layer.

When the unidirectional layers each have different longitudinal directions with respect to one another, then a biaxial fiber fabric is obtained from using two layers, a triaxial fabric is obtained from using three unidirectional layers, and a quadraxial fabric is obtained from using four unidirectional layers.

The production of a unidirectional fiber layer and of a fiber fabric, especially a multi-axial fiber fabric, is explained below in more detail. In addition, other manufacturing processes may be selected by a person skilled in the art. During the spreading of a fiber to obtain a unidirectional orientation, a fiber may be led first, for example, through one or more devices that allow the tension of the fiber to be controlled, and then passed through one or more devices for spreading the fiber in order to obtain unidirectional strips. A unidirectional strip can then be led through a device with one or more additional strips to bring them together to form a unidirectional layer. The one or more additional strips may be produced from fibers of the same or different materials. Optionally, a fiber layer, especially a unidirectional layer may be treated with a binder after it is formed. Fibers made from the same or different filaments as well as fibers with mixed filaments of different materials, may be used in the method according to the invention.

Several unidirectional layers may then be combined to form a fiber fabric, especially a multi-axial fiber fabric. Unidirectional layers may be used here and are preferably so arranged with respect to one another, that at least two of the longitudinal directions of the unidirectional layers form an angle of more than 5° with respect to one another. The unidirectional layers so used may have the same width or not. In the production of a multi-axial fiber fabric, a person skilled in the art would select one direction to be taken as the reference direction that is referred to as the 0° direction. Often the 0° direction corresponds to the longitudinal direction of the fiber structure to be produced. A unidirectional layer running parallel to this direction is designated as a 0° layer.

When using two or more unidirectional layers, the two or more additional unidirectional layers are preferably arranged in such a manner that their respective longitudinal directions form the opposite sign with respect to the 0° angle direction, wherein the angular amount may be equal (and the angle may be, for example, +60°/−60° or +45°/−45)° or may be different, or their respective longitudinal directions lie at angles of 0° and 90° to the 0° direction.

The term “carbon fiber” as used in the present application includes any carbon fiber that can be produced from a raw material fiber containing carbon, such as a fiber based on polyacrylonitrile, a fiber based on polyacetylene, a fiber based on polyphenylene, a fiber based on pitch, or a fiber on the basis of cellulose, wherein this term especially refers to fibers having a carbon content higher than 75 wt. %, preferably more than 85 wt. %, preferably from more than 92 wt. %, with respect to the total weight of the fiber.

The term “carbon fiber precursor fiber” as used in the present application includes any fiber that can be produced from a starting material fiber containing carbon fiber and used for the numerous examples given above, wherein a “carbon fiber precursor fiber”, however, has already undergone chemical or mechanical changes such as oxidation in comparison to the starting material fiber. Examples of carbon fiber precursor fibers (often abbreviated as PAN-Ox) include, among others, pre-oxidized polyacrylonitrile fibers, pre-oxidized viscose fibers, any pre-oxidized textile fibers, phenolic resin fibers, pitch-based precursor fibers, and mixtures thereof, although this list should not be seen as conclusive.

A fiber that is suitable for use as raw material for producing carbon fibers and carbon fiber precursor fibers is a fiber based on polyacrylonitrile. In addition, a fiber based on polyacrylonitrile may be used to produce a fiber layer as such.

Production process for polyacrylonitrile fibers, pre-oxidized polyacrylonitrile fibers and carbon fibers made from them are shown in the publication of E. Fitzer, L. M. Manocha, “Carbon Reinforcements and Carbon/Carbon Composites,” Springer Verlag, Berlin, 1998, ISBN 3-540-62933-5, p. 10-24, as well as described in the publications U.S. Pat. No. 4,001,382, U.S. Pat. No. 6,326,451, EP 0 384 299 B1 and U.S. Pat. No. 6,054,214.

Starting material fibers for producing a pitch-based precursor fiber may be either isotropic as well as anisotropic pitch fibers. To produce such starting material fibers, mesophase pitch is subjected to a melt spinning process and stretched as long as it is plastically deformable, wherein pitch fibers may be produced with a preferred orientation. Suitable production methods for pitch fibers and pitch-based precursor fibers are known in the state of the art and are described in the publication by E. Fitzer, LM Manocha, “Carbon Reinforcements and Carbon/Carbon Composites,” Springer Verlag, Berlin, 1998, ISBN 3-540-62933-5, p. 24-34, and described in the patent DE 697 32 825 T2.

Methods for producing phenol resin fibers as well as production of binding threads from these threads are known to a person skilled in the art. In addition, such methods are described, for example, in DE 2 308 827 and DE 2 328 313.

Ceramic fibers used, for example, for fiber layers or affixing binding threads, oxide and/or non-oxide fibers, are based on one or more compounds containing at least one, preferably at least two, of the elements including carbon, silicon, boron, titanium, zirconium, tungsten, aluminum and nitrogen. Preferably, the ceramic fibers are made entirely or at least 90 wt. %, based on the total weight of the ceramic fiber including compounds containing at least two of the elements including carbon (C), silicon (Si), boron (B), titanium (Ti), zirconium (Zr), tungsten (W), aluminum (Al) and nitrogen (N). In particular, ceramic fibers are used where the sum of the contents of C, Si, B, N, Al, Zr, Ti, W is more than 50 wt. %, preferably more than 83 wt. %, preferably more than 85 wt. %, especially more than 95 wt. % of the total weight of the ceramic fibers, where the content of one or more of the elements C, Si, B, N, Al, Zr, Ti, W may be 0 wt.-%.

For example, fibers, especially high-temperature resistant fibers, are used based on Si, C, B, N, Al or combinations thereof (all such fibers, for example, denoted in DE 197 11 829 C1 also called “Si/C/B/N-fibers”), and, in particular, ceramic fibers based on compounds comprising at least two of these elements. Such fibers are described, for example in DE 197 11 829 C1. Ceramic fibers may, for example, include or consist of at least one compound selected from alumina, zirconia, SiNC, SiBNC, SiC, B4C, BN, Si3N4, TiC, WC, and mixtures thereof completely or at least 90 wt. %, preferably at least 93 wt. %, based on the total weight of the fibers. In particular, ceramic fibers may be basalt fibers and/or glass fibers or a mixture thereof.

The method for the production of basalt fibers, as well as production of binding threads from these threads are known to a person skilled in the art. In addition, such methods are described, for example, in DE 195 38 599 A1, CH 96640.

Methods

a) Determining the Weight of Threads

Unless explicitly stated otherwise, the terms “weight of the thread” or “the total weight of the thread” refer to a dry fiber, as well as to a thread before application of an affixing fluid (or so-called “wash”), whereby the drying is performed using drying methods known in the state of the art. Preferably, drying takes place in accordance with ISO 1889.

b) Determination of Mass Loss of a Filament on Heating

After determining the weight of a dry thread, obtained as described in the previous paragraph a) above, at 20° C., the dry thread is subjected to an inert atmosphere at a pressure of 1013 hPa and at a temperature of 20° C., where the inert atmosphere is 99.9 wt. % of nitrogen based on the total weight of the inert atmosphere, is heated for 12 hours at a respective selected temperature, as explained above (in the case of a high temperature resistant thread: 405° C., a very high temperature resistant thread: 410° C., an especially high temperature resistant thread: 600° C., an extremely high temperature resistant thread: 900° C., a highest high temperature resistant thread: 2000° C.). After reaching the selected temperature, the temperature is kept constant for 8 hours. Then cooling takes place for 20 hours at 20° C.

After cooling to 20° C., the relative weight of the thread treated at the selected temperature is compared with the respective weight of the dry thread before heating, and the mass loss determined.

c) Determination of the Tensile Strength of a Thread after Heating

The thread is subjected to an inert atmosphere at a pressure of 1013 hPa and at a temperature of 20° C., where the inert atmosphere is 99.9 wt. % of nitrogen based on the total weight of the inert atmosphere, is heated for 12 hours at a respective selected temperature (400° C., preferably 410° C., preferably 600° C., more preferably 900° C., especially 2000° C.). After reaching the target temperature, the temperature is kept constant for 8 hours. Then cooling takes place for 20 hours at 20° C. The tensile strength is determined after cooling according to ASTM D3379-75.

d) Other Methods

The determination of maximum tensile strength and the tensile strength may be performed in accordance with a procedure known to a person skilled in the art. In particular, determination may be performed in accordance with ASTM D3379-75.

The weight of fibers, such as that of a fiber layer, is the weight of dry fibers, wherein the drying may take place using a drying method known to person skilled in the art. Preferably, drying takes place in accordance with ISO 1889.

When there are several versions available of standards such as DIN, ISO or ASTM standards, reference should be made to the most current version as of Aug. 1, 2008.

The invention will now be further illustrated by the following non-exclusive examples:

### EXAMPLES

### Example 1

### Production of a Fiber Fabric and its Further Processing

Heavy-tow carbon fibers with 50,000 individual filaments from the SGL Group, Meitingen, Germany, having the trade designation Sigrafil C30 T050 EPY were processed on a multi-axial fabric machine, to produce biaxial fabric with a weight of 450 g/m2. Sigrafil C30 fibers have a diameter of 6.5 microns, a density of 1.80 g/cm³, a tensile strength of 3.8 GPa (determined in accordance with ASTM D3379-75, “tensile strength”), a carbon content in accordance with ASTM D5291-02 of >95 wt. % based on the total weight of the fiber.

To achieve the required thermal stability of the fabric in the subsequent thermal process, especially during the above-described high-temperature treatment, various binding threads were used as affixing binding threads with high thermal stability. Fabrics with only one type of binding thread as well as with combinations of binding threads were tested here.

FIG. 1 shows an example of a +/−45° fabric (fiber fabric with unidirectional layers where the longitudinal directions of the unidirectional layers formed angles of +45° and −45° to the longitudinal direction of the fiber fabric (0° direction)) with a sample seam of yarn of pre-oxidized polyacrylonitrile (PAN-Ox) (trade name of the yarn: Sigrafil Nm25/2, yarn fineness. 1.7 dtex, available from SGL Group, Meitingen, Germany). The sample seam can be seen in FIG. 1 as the fifth seam from the top that is made of relatively darker yarn. The other seams are made of yarn of the prior art that is not destroyed when heated to 2000° C.

FIG. 2 shows the same fabric after heating to 2000° C. for 8 hours under an inert atmosphere, of at least 99.9 wt. % nitrogen. The PAN-Ox binding thread has withstood the graphitization with the necessary strength to undergo impregnation (prepreg process), while the yarn of the prior art has withstood the heating without destruction. Experiments were performed where heating to 2200° C. gave similar results. Adequate strength of the seam for the subsequent impregnation (prepreg process) could be detected.

Similar results were also obtained, for example, even when a staple binding yarn of spun stretch-torn, pre-oxidized polyacrylonitrile (trade name of the yarn: Sigrafil SPO Nm14/2, available from SGL Group, Meitingen, Germany) or a carbon fiber yarn or a combination of at least two yarns selected from among carbon fiber yarn, staple fiber and yarn from the pre-oxidized polyacrylonitrile, were used as the binding thread.

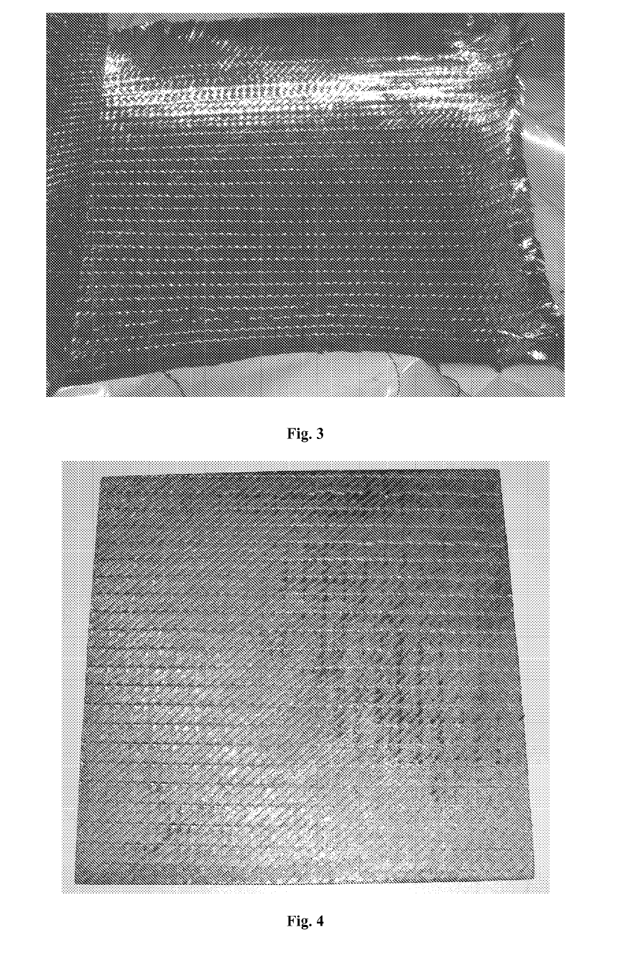

FIG. 3 shows an example of a +/−45° graphitized fabric stitched with carbon fiber. The fabric remained inherently stable due to the thermal resistance of the binder threads used so that this could be processed into prepregs in a subsequent impregnation with phenolic resin as a matrix. The graphitization was carried out for 8 hours at 2000° C. under an inert atmosphere containing at least 99.9 wt. % nitrogen.

The prepregs produced from the graphitized fabric described above were processed into carbon fiber reinforced carbon ceramics. In this case, the prepreg was first heated as a sample plate to temperatures of up to 180° C. over a period of up to eight hours, more preferably up to three hours and under pressure, to obtain a green body. In the present example, the sample plate was pressed at 150° C. for 4 hours under a pressure of 10 N/cm2. This green body was then heat treated in subsequent steps; first for 8 hours at a temperature of 1000° C. under an inert atmosphere, containing at least 99.9 wt. % nitrogen (carbonated), and then impregnated with impregnating pitch and then burned again at a temperature of 1000° C. for 8 hours under an inert atmosphere containing at least 99.9 wt. % nitrogen.

For example, for the compaction, thermoset resin with high carbon yields, particularly from the group of phenolic resins, may also be used. Experiments with pitches and derivatives also show good results. The number of compactions required depends on the desired target density of the carbon fiber reinforced carbon ceramic, but is carried out up to four times to give densities of 1.30-1.58±0.03 g/cm3.

In the manner described above, the carbon fiber reinforced carbon ceramic so obtained was characterized by a subsequent heating to 2000° C. for 8 hours in an inert atmosphere. FIG. 4 shows this carbon fiber reinforced carbon ceramic. The properties obtained are summarized in Table 1.

TABLE 1
Overview of properties of carbon fiber reinforced
carbon ceramic produced according to Example 1

| | | Orientation | |
|---|---|---|---|
| Property | Units | 0° (Sample 1) | 45° (Sample 2) |
| Density | [g/cm³] | 1.47 | 1.47 |
| Bending strength | [MPa] | 127.3 | 52.0 |
| Interlaminar shear strength | [MPa] | 5.6 | 5.0 |
| Specific electric resistance | [Ohm μm] | 26.0 | 27.0 |

Samples 1 and 2 are each rectangular specimens that were cut from the composite material. Sample 1 has longitudinal edges that run parallel to the grain, while Sample 2 has longitudinal edges that run at 45° to the fiber direction.

### Example 2

### Change in Tensile Strength of a Pre-Oxidized Polyacrylonitrile Fiber when Heated to 2000° C.

The following table compares the tensile strength of PAN-Ox yarn (yarn of pre-oxidized polyacrylonitrile) (yarn designation: Nm25/2, available from SGL Group, Meitingen, Germany), which can be used for the production of a fiber fabric in accordance with the invention, before and after treatment at 2000° C. In this treatment, the yarn is heated under an inert atmosphere at a pressure of 1013 hPa and at a temperature of 20° C., where the inert atmosphere contains 99.9 wt. % nitrogen based on the total weight of the inert atmosphere, for 12 hours at 2000° C. After reaching 2000° C., the temperature was kept constant for 8 hours. Then cooling took place for 20 hours at 20° C.

TABLE 2

| | Meter weight | Ultimate tensile | Tensile strength |
|---|---|---|---|
| Treatment | [g/m] | strength [N] | [MPa] |
| untreated | 0.080 | 7.2 | 124 |
| treatment at | 0.034 | 8.2 | 435 |
| 2000° C. | | | |

The determination of ultimate tensile strength and tensile strength according to ASTM D3379-75.

Surprisingly, it turns out that both the ultimate tensile strength as well as the tensile strength of PAN-Ox yarn increased after the heat treatment. This shows that yarn, including or consisting of the precursor fiber of carbon fibers, especially PAN-Ox yarn, serves very well as affixing thread for producing suitable composite materials and fiber fabric in accordance with the invention.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for producing a fiber-clutch reinforced composite material, said method comprising the steps of:
a) preparing a fiber clutch, including:
preparing an arrangement of at least two fiber layers that are one of partially and completely disposed one on top of another, at least one of said fiber layers including at least 50 wt. % of a plurality of fibers selected from the group consisting of carbon fibers, carbon fiber precursor fibers, ceramic fibers, and a plurality of mixtures thereof; and
affixing at least one said fiber layer onto at least one other said fiber layer using an affixing binder thread, said affixing involving passing said affixing binder thread through at least one said fiber layer and through at least one other said fiber layer, said affixing binder thread including at least one fiber selected from the group consisting of said carbon fibers, said carbon fiber precursor fibers, said ceramic fibers, and a plurality of mixtures thereof;
b) treating with a high temperature said fiber clutch at a temperature of at least 400° C. under an inert atmosphere for a high temperature treatment period;
c) impregnating said fiber clutch treated with said high temperature with at least one binder; and
d) curing an impregnated said fiber clutch during a curing period at a curing temperature of at least 40° C., the fiber-clutch reinforced composite material being formed.

2. The method according to claim 1, further including pressing at least one surface section of at least one surface of said impregnated fiber clutch at least one of before beginning and at least during a portion of said curing period, the fiber-clutch reinforced composite material being formed, the method further including obtaining one of the fiber-clutch reinforced composite material and a fiber-clutch reinforced composite material product after said steps of curing and pressing.

3. The method according to claim 1, further including treating thermally one of the fiber-clutch reinforced composite material and a fiber-clutch reinforced composite material product, and obtaining a thermally treated said one of the fiber-clutch reinforced composite material and said fiber-clutch reinforced composite material product after said step of treating thermally.

4. The method according to claim 3, further including at least one of densifying, siliconizing, and gas phase coating of one of said thermally treated fiber-clutch reinforced composite material and said thermally treated fiber-clutch reinforced composite material product, and obtaining at least one of a densified, siliconized, and gas phase coated said one of the fiber-clutch reinforced composite material and said fiber-clutch reinforced composite material product after said step of at least one of densifying, siliconizing, and gas phase coating.

5. The method according to claim 1, wherein said affixing involves sewing.

6. The method according to claim 1, wherein at least one said fiber layer includes one of more than 70 wt. %, more than 85 wt. %, more than 92 wt. %, and more than 98 wt. % of said plurality of fibers selected from the group including said carbon fibers, said carbon fiber precursor fibers, said ceramic fibers, and said plurality of mixtures thereof, related to a total weight of a respective said fiber layer.

7. The method according to claim 1, wherein said affixing binder thread is used with a sum of contents of elements C, Si, B, N, Al, Zr, Ti, W being one of more than 50 wt. %, more than 83 wt. %, more than 85 wt. %, and more than 95 wt. % of a total weight of said affixing binder thread, wherein a content of at least one of said elements C, Si, B, N, Al, Zr, Ti, W is 0 wt. %.

8. The method according to claim 1, wherein said affixing binder thread is one of partially and completely enveloped by an affixing liquid before said step of affixing.

9. The method according to claim 8, wherein said affixing liquid includes at least one compound selected from the group including water, silicone oils, polyurethanes, epoxide resin compounds, epoxy esters, polyvinyl alcohols, waxes, fatty acid esters, polyurethane esters, polyurethane ethers, and a plurality of mixtures hereof.

10. The method according to claim 1, wherein said step of affixing includes a mounting-fixation thread entering a first said fiber layer at a first entry point, being fed through said first fiber layer and at least a next said fiber layer, and leaving at a first emersion point in at least said next fiber layer.

11. The method according to claim 10, wherein said mounting-fixation thread enters through a second entry point in at least said next fiber layer, is fed through at least another next said fiber layer and said first fiber layer, and leaves at a second emersion point on said first fiber layer.

12. The method according to claim 1, wherein at least one of said carbon fiber precursor fibers of said affixing binder thread is selected from the group including pre-oxidized textile fibers, pre-oxidized viscose fibers, pre-oxidized polyacrylnitrile fibers, phenolic resin fibers, pitch-based precursor fibers, and a plurality of mixtures thereof.

13. The method according to claim 1, wherein at least one of said ceramic fibers of said affixing binder thread is selected from the first group including basalt fibers, Si-, C-, B-, N-, Al-based fibers or compounds thereof, glass fibers, aluminum oxide-based fibers, zircon oxide-based fibers, TiC-based fibers, WC-based fibers, and a plurality of mixtures thereof.

14. The method according to claim 13, wherein at least one of said ceramic fibers is selected from the second group including basalt fibers, fibers including SiNC, SiBNC, SiC, B₄C, BN, Si₃N₄, aluminum oxide, zircon oxide, TiC, WC, a plurality of mixtures thereof, and a plurality of mixtures of said first group and said second group.

15. The method according to claim 1, wherein at least one said fiber layer has a surface-specific weight one of in a range of 50 g/m² to 500 g/m², in a range of 150 g/m² to 350 g/m², and in a range of at least 305 g/m² to 500 g/m².

16. The method according to claim 1, wherein a number of filaments in at least one said fiber layer is one of in a range of 500 filaments to 500,000 filaments, in a range of 1,000 filaments to 400,000 filaments, and in a range of 12,000 filaments to 60,000 filaments.

17. The method according to claim 1, wherein said affixing binder thread includes at least one of at least one resin and at least one inorganic impregnating agent, wherein at least one of (a) said at least one resin is selected from the group including phenolic resins, epoxide resins, benzoxazine resins, cyanate ester resins, polyester/vinyl ester resins, polyimide resins, furan resins, polyacrylate resins, and a plurality of mixtures thereof, and (b) said at least one inorganic impregnating agent is selected from the group including silicone, SiC-precursor polymers, SiC-precursor oligomers, and a plurality of mixtures thereof.

18. The method according to claim 1, wherein at least one of at least one and all said fiber layers are in a same direction.

19. The method according to claim 1 wherein said affixing binder thread has one of a linear density of not more than 1 Tex, a linear density in a range of 0.04 to 1 Tex, and a linear density in a range of 0.04 to 0.75 Tex, determined in accordance with DIN 60905.

20. One of a fiber-clutch reinforced composite material and a fiber-clutch reinforced composite material product, comprising:
said one of the fiber-clutch reinforced composite material and the fiber-clutch reinforced composite material product being obtained according to the following method:
a) preparing a fiber clutch, including:
preparing an arrangement of at least two fiber layers that are one of partially and completely disposed one on top of another, at least one of said fiber layers including at least 50 wt. % of a plurality of fibers selected from the group consisting of carbon fibers, carbon fiber precursor fibers, ceramic fibers, and a plurality of mixtures thereof; and
affixing at least one said fiber layer onto at least one other said fiber layer using an affixing binder thread, said affixing involving passing said affixing binder thread through at least one said fiber layer and through at least one other said fiber layer, said affixing binder thread including at least one fiber selected from the group consisting of said carbon fibers, said carbon fiber precursor fibers, said ceramic fibers, and a plurality of mixtures thereof;
b) treating with a high temperature said fiber clutch at a temperature of at least 400° C. under an inert atmosphere for a high temperature treatment period;
c) impregnating said fiber clutch treated with said high temperature with at least one binder; and
d) curing an impregnated said fiber clutch during a curing period at a curing temperature of at least 40° C., the fiber-clutch reinforced composite material being formed.

21. The one of the fiber clutch reinforced composite material and the fiber-clutch reinforced composite material product according to claim 20, wherein the method further includes treating thermally the one of the fiber-clutch reinforced composite material and the fiber-clutch reinforced composite material product, and obtaining a thermally treated one of the fiber-clutch reinforced composite material and the fiber-clutch reinforced composite material product after said step of treating thermally.

22. The one of the fiber clutch reinforced composite material and the fiber-clutch reinforced composite material product according to claim 21, wherein the method further includes at least one of densifying, siliconizing, and gas phase coating of one of said thermally treated fiber-clutch reinforced composite material and said thermally treated fiber-clutch reinforced composite material product, and obtaining at least one of a densified, siliconized, and gas phase coated said one of the fiber-clutch reinforced composite material and said fiber-clutch reinforced composite material product after said step of at least one of densifying, siliconizing, and gas phase coating.

23. A fiber clutch, comprising:
the fiber clutch being obtained according to the following method:
a) preparing a fiber clutch, including:
preparing an arrangement of at least two fiber layers that are one of partially and completely disposed one on top of another, wherein at least one of said fiber layers corresponding to a total weight of a respective said fiber layer includes at least 50 wt. % of a plurality of fibers selected from the group consisting of carbon fibers, carbon fiber precursor fibers, ceramic fibers, and a plurality of mixtures thereof; and
affixing at least one said fiber layer onto at least one other said fiber layer using an affixing binder thread, said affixing involving passing said affixing binder thread through at least one said fiber layer and through at least one other said fiber layer, said affixing binder thread including at least one fiber selected from the group consisting of said carbon fibers, said carbon fiber precursor fibers, said ceramic fibers, and a plurality of mixtures thereof;
b) treating with a high temperature said fiber clutch at a temperature of at least 400° C. under an inert atmosphere for a high temperature treatment period.

24. A method of using one of a composite material and a composite material product, said method comprising the steps of:
providing that said one of the composite material and the composite material product is respectively one of a fiber-clutch reinforced composite material and a fiber-clutch reinforced composite material product;
obtaining said one of said fiber-clutch reinforced composite material and said fiber-clutch reinforced composite material product according to the following method:
a) preparing a fiber clutch, including:
preparing an arrangement of at least two fiber layers that are one of partially and completely disposed one on top of another, at least one of said fiber layers including at least 50 wt. % of a plurality of fibers selected from the group consisting of carbon fibers, carbon fiber precursor fibers, ceramic fibers, and a plurality of mixtures thereof; and
affixing at least one said fiber layer onto at least one other said fiber layer using an affixing binder thread, said affixing involving passing said affixing binder thread through at least one said fiber layer and through at least one other said fiber layer, said affixing binder thread including at least one fiber selected from the group consisting of said carbon fibers, said carbon fiber precursor fibers, said ceramic fibers, and a plurality of mixtures thereof;
b) treating with a high temperature said fiber clutch at a temperature of at least 400° C. under an inert atmosphere for a high temperature treatment period;
c) impregnating said fiber clutch treated with said high temperature with at least one binder; and
d) curing an impregnated said fiber clutch during a curing period at a curing temperature of at least 40° C., the fiber-clutch reinforced composite material being formed; and
using said one of said fiber-clutch reinforced composite material and said fiber-clutch reinforced composite material product for at least one of manufacturing furnaces, manufacturing lining for heating areas of furnaces, heating elements, chemical reaction devices or elements thereof, and hot press molds.

25. One of an element and a device, comprising:
one of a composite material and a composite material product, said one of said composite material and said composite material product being respectively one of a fiber-clutch reinforced composite material and a fiber-clutch reinforced composite material product, said one of said fiber-clutch reinforced composite material and said fiber-clutch reinforced composite material product being obtained according to the following method:
a) preparing a fiber clutch, including:
preparing an arrangement of at least two fiber layers that are one of partially and completely disposed one on top of another, at least one of said fiber layers including at least 50 wt. % of a plurality of fibers selected from the group consisting of carbon fibers, carbon fiber precursor fibers, ceramic fibers, and a plurality of mixtures thereof; and
affixing at least one said fiber layer onto at least one other said fiber layer using an affixing binder thread, said affixing involving passing said affixing binder thread through at least one said fiber layer and through at least one other said fiber layer, said affixing binder thread including at least one fiber selected from the group consisting of said carbon fibers, said carbon fiber precursor fibers, said ceramic fibers, and a plurality of mixtures thereof;
b) treating with a high temperature said fiber clutch at a temperature of at least 400° C. under an inert atmosphere for a high temperature treatment period;
c) impregnating said fiber clutch treated with said high temperature with at least one binder; and
d) curing an impregnated said fiber clutch during a curing period at a curing temperature of at least 40° C., the fiber-clutch reinforced composite material being formed,
wherein said one of the element and the device is selected from the group including furnaces, an inner lining of furnaces, a heating area lining of furnaces, heating elements, chemical reaction devices or components thereof, and hot press molds.
